(19) United States
(12) Patent Application Publication
(10) Pub. No.: US 2007/0182733 A1
(43) Pub. Date: Aug. 9, 2007

(54) Three-dimensional cad system

(75) Inventor: Kenji Imanishi, Fujisawa-shi (JP)

Correspondence Address: CROWELL & MORING LLP;INTELLECTUAL PROPERTY GROUP, P.O. BOX 14300, WASHINGTON, DC, 20044-4300, US

(73) Assignee: NSK LTD., SHINGAWA-KU (JP)

(21) Appl. No.: 10/594,079

(22) PCT Filed: Jun. 21, 2005
(86) PCT No.: PCT/JP05/11365

§ 371 Date: Sep. 25, 2006

(30) Foreign Application Priority Data
Sep. 22, 2004 (JP) 2004-275268

(51) Int. Cl. G06T 17/00

(52) U.S. Cl. 345/420

(57) ABSTRACT

It is possible to match a parts model with a two-dimensional drawing. A parts model has shape changing elements whose shapes are changed before and after assembling and other common elements. Three-dimensional shape data on the shapes of the shape changing elements before assembling and their shapes after assembling and the shapes of the common elements are stored as three-dimensional shape data on the parts model in database 12. A calculation unit 14 sets a restriction condition to become a single part between the shapes of the shape changing elements before assembling and the shapes of the common elements for the three-dimensional shape data stored in the database 12 and sets a restriction condition to become a single part between the shapes of the shape changing elements after assembling and the shapes of the common elements, so that three-dimensional shape data is spread into the two-dimensional drawing according to the restriction condition and displayed on the screen of the display unit 16.

### TECHNICAL FIELD

The present invention concerns a three-dimensional CAD system and, more in particular, it relates to a three-dimensional CAD system suitable to preparation of a two-dimensional drawing based on a three-dimensional shape information of a model.

### BACKGROUND ART

As three-dimensional CAD systems, those having a function of projecting a shape from a prepared model and preparing a two-dimensional drawing have been known. In the three-dimensional CAD systems of this type, parts models that express parts and a product model that expresses a state of combining parts models are used as the model. Generally, the parts model defines a state before assembling into a product, and the product model defines a state after assembling parts and defines constituent parts as a hierarch structure. In a case where a part whose shape is changed between a state as an elemental part and an assembled state is present in a product, for example, a part applied with caulking fabrication or the like, since the part changes the shape upon assembling into the product, as a model for the part, a parts model expresses a shape after assembling the part into the product is necessary separately from a parts model that expresses the shape before assembling into the product.

Accordingly, for the product in which a part whose shapes is changed between a state as an elemental part and the state upon assembling is present, it has been adopted a constitution of handling a part in the elemental part state (part before assembling) and a part in an assembled state (part after assembling) as separate parts.

For example, as shown in FIG. 9A in a case where a Product A comprises parts B, C, D, and E and the shape of the part B is changed before and after assembling, parts models are provided as: model 1 for part B, model 2 for part C before asembling,model 3 for part C after assembling, model 4 for part D. and model 5 for part E, and, in the switching before and after assembling, models 1, 2, 4 are displayed and model 3 after assembling the part C is not displayed before assembling. Further, as shown in FIG. 9B, models 1, 3, 4, and 5 are displayed and the model 2 before assembling the part C is not displayed after assembling.

Further, as shown in FIG. 10, for managing the model before and after assembling quite separately, only the parts in the assembled state are handled for the product constitution information and parts in the elemental state are managed separately. That is, only the model 2 concerning the part before assembling is handled as a model in the state of elemental part before assembling, and model 1 for the part B, model 3 for the part C after assembling, model 4 concerning the part D, and the model 5 concerning the part E are handled as the model after assembling.

In the prior art, upon defining the product model, since it is defined in the state after assembling the parts, parts constituting the product are defined as a hierarchical structure, and the product constituent information is recorded, for example, in the product constitution management data base, this can be in association with a system of managing common parts or a system of automatically calculating the necessary number of parts to prepare the product.

However, in a case where a part whose shape is changed after assembling into the part is present, since a parts model that expresses the shape after assembling into the product is necessary, a product constituent information prepared by the parts model that expresses the shape before assembling into the product is no more correct. In order to put the product constituent information in a correct state, it is necessary to manage the parts model separately from the product model. Further, it may be possible to define the shape before and after assembling in one parts model and switch the shape with no display. However, when the method is adopted, since the content thereof reflects also on the shape of the two-dimensional drawing at the same time with the switching of the shape, the shape after assembling and the shape before assembling are not sometimes matched.

The subject of the invention is to match the parts model and the two-dimensional drawing.

### DISCLOSURE OF THE INVENTION

In order to solve the subject described above, the present invention adopts a method of creating a two-dimensional drawing based on a three-dimensional model by using a computer source including; a processing device source, a memory source, an input device, and an interface, in which the processing device source executes a processing including a step of holding, as a three-dimensional shape information of a parts model having a shape changing element whose shape is changed before and after assembling and other common elements, three-dimensional information on the shape before assembling and the shape after assembling of the shape changing element, and the shape of other common elements, a step of setting a restriction condition between the shape before assembling of the shape changing element and the shape of the common element to become a single part to each other, a step of setting a restriction condition between the shape after assembling of the shape changing element and the shape of the common elements to become a single part to each other, and a step of developing the held three-dimensional information into the two-dimensional drawing in accordance with each of the restriction conditions, based on an operation program of the memory source.

Upon adopting the two-dimensional drawing creation method, the parts model is judged whether it is in a state before or after assembling, and it is possible to add a step of not displaying the shape after assembling of the shape changing element while displaying the shape before assembling of the shape changing element and the shape of the common elements before assembling and to add a step of not displaying the shape before assembling of the shape changing element while displaying the shape after assembling of the shape changing element and the shape of the common elements after assembling.

Further, the present invention provides a three-dimentional CAD system including a data base that holds, as three-dimensional shape information of a parts model having a shape changing element whose shapes is changed before and after assembling and other common elements, three-dimensional information on the shape before assembling and the shape after assembling of the shape changing element and the shape of the common elements, and a calculation unit that sets a restriction condition between the shape of the shape changing element before assembling and the shapes of the common elements to become a single part to each other, sets a restriction condition between the shape after assembling of the shape changing element and the shape of the common elements to become a single part to each other and develops the three-dimensional shape information held in the data base into a two-dimensional drawing in accordance with each of the restriction conditions.

According to the means described above, since the shapes before and after assembling are defined with one parts model, the parts model and the two-dimensional drawing can be matched and the file can be managed easily.

In constructing the three-dimensional CAD system, the following elements can be added.

The system has a display unit for displaying the two-dimensional drawing on a screen, in which the calculation unit judges for the parts model as to whether it is before or after assembling, does not display the shape after assembling of the shape changing element while displaying the shape before assembling of the shape changing elements and the shape after assembling of the common elements on a display screen before assembling, and does not display the shape before assembling of the shape changing element while displaying the shape after assembling of the shape changing elements and the shape of the common elements on the display screen after assembling.

Further, the present invention concerns a program for causing a computer to execute processing attained with each of the means, and a memory medium for storing the program. The memory medium can include memory means such as CD-ROM and DVD-ROM.

### DESCRIPTION OF THE DRAWINGS

FIG. 1 is a block diagram of a three-dimentional CAD system showing an example of the present invention.

FIG. 2 is an explanatory view for the constitution of a parts model.

FIG. 3 is an explanatory view for the constitution of another parts model.

FIG. 4 is a flow chart for explaining the display method before and after assembling the parts model.

FIG. 5 is a constitutional view for explaining a relation between a product model and a parts model.

FIG. 6 is a constitutional view for explaining a relation between the product model and the parts model with the shapes before and after assembling being as a sub-assembly.

FIG. 7 is a view for explaining the shape when a rivet 40 developed into a two-dimensional drawing.

FIG. 8 is a drawing for explaining the shape when an oil seal 50 is developed into a two-dimensional drawing.

FIGS. 9A and 9B are views for explaining the constitution of a conventional parts model in which FIG. 9A is a view for explaining displayed/not displayed parts model before assembling and FIG. 9B is a view for explaining displayed/not displayed parts model after assembling.

FIG. 10 is a view for explaining a conventional management method for a parts model, which is a view for explaining the method of managing models before and after assembling separately.

### DESCRIPTION OF REFERENCES

10 input unit
12 data base
14 calculation unit
16 display unit
   Best Mode for Practicing the Invention

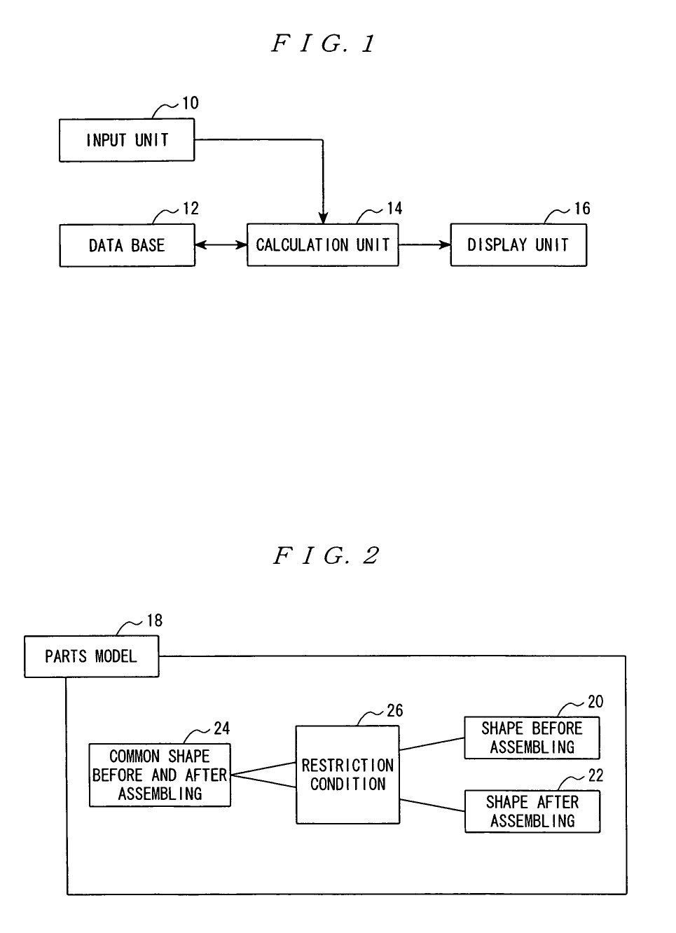

An embodiment of the present invention is to be described in accordance with examples. FIG. 1 is a block diagram showing a three-demensional CAD system showing an example of the invention.

In FIG. 1, a three-dimensional CAD system includes a computer comprising an input unit (input device) 10, a data base (memory source) 12, a calculation unit (a processing device source and interface) 14 and a display unit (display device) 16.

The input unit 10 is constituted as input means for inputting various date on parts models, product models, etc. into the calculation unit 14.

The calculation unit 14 stores the data inputted from the input unit 10 to the data base 12, conducts various types of calculations based on the inputted data and the operation program, sets the restriction conditions, etc., stores data such as the result of calculation and the restriction conditions in the data base 12, develops the data as the three-dimensional shape information among the data stored in the data base 12 into the two-dimensional drawing in accordance with various restriction conditions and displays the developed two-dimensional drawing on the screen of the display unit 16. Further, the calculation unit 14 judges whether the product is before or after assembling and puts the shape of the model in a not-display or display state in accordance with the result of the judgment.

Specifically, upon generating the product constituent information of a product comprising a plurality of parts, in a case where a part whose shape is changed before and after assembling is present, the calculation unit 14 divides a part into a shape changing element whose shapes is changed before and after assembling and other common elements, generates the three-dimensional shape data on the shape 20 of the shape changing element before assembling, the shape 22 of the shape changing element after assembling, and the shape of the common elements (shape in common before and after assembling) 24, as shown in. FIG. 2, as the data on the three-dimensional shape information of a parts model 18 having the shape changing element and the common elements, stores the generated three-dimensional shape data in the data base 12, and holds the three-demensional shape data in the data base 12. In this case, the calculation unit 14 sets the restriction condition 26 on every shapes upon storing the three-dimensional shape data on the shape 20 before assembling and the shape after assembling of the shape changing element and the shape 24 of the common elements in the data base 12.

For example, it sets the restriction condition 26 between the shape 20 of the shape changing element before assembling and the shape 24 of the common element so as to become a single part to each other and sets a restriction condition 26 between the shape 22 of the shape changing element after assembling and the shape 24 of the common elements so as to become a single part to each other. That is, contact, conformity, dimension, etc. are attached to the coordinate system, plane, etc. for the elements in the parts model 18 and the elements other than the parts model 18 to restrict the position.

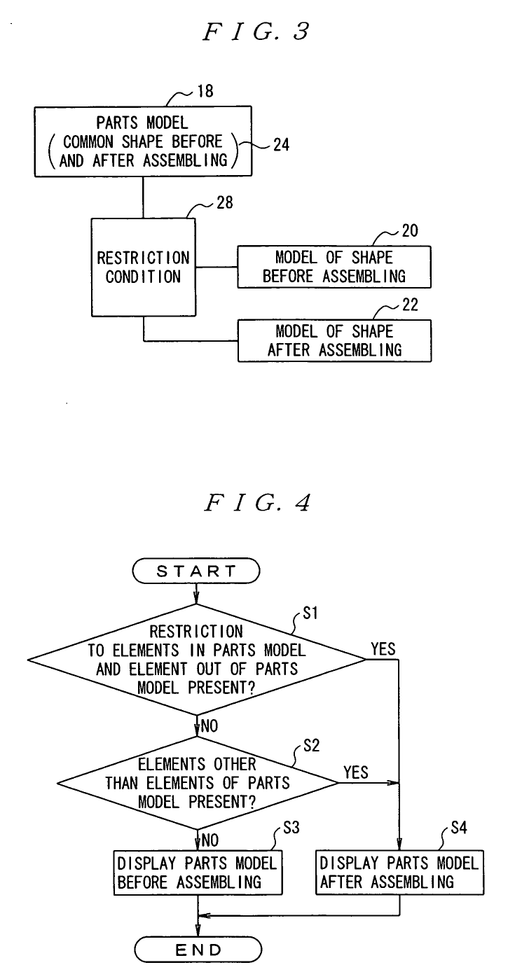

On the other hand, as another method, as shown in FIG. 3, it is also possible to define a shape 20 of the shape changing element before assembling and the shape 22 after assembling thereof each as a sub-assembling relative to the parts model 18, and set a restriction condition 28 between the common shape (shape of common element) 24 in common before and after assembling and a shape 20 before assembling to become a single part to each other and sets a restriction condition 28 between the shape 22 of the shape changing element after assembling and the common shape (shape of common element) 24 in common before and after assembling to become a single part to each other.

Further the calculation unit 14 judges whether the state is before or after assembling and does not display or displays the shape in accordance with the result of the judgment. For example, in a case where the restriction condition is set to the element not present in the parts model 18, it is judged as being after assembling and in a case where the restriction condition is not set to the element not present in the parts model 18, it is judged as before assembling. Further, it may be judged as being after assembling even in a case where the restriction condition is not set to the element not present in the parts model 18, also in a case where there is an element not present in the parts model 18.

Specifically, as shown in FIG. 4, it is judged as to whether restriction is present or not between the element in the parts model 18 and the element out of the parts model 18 (restriction condition is set) (step S1), and it is judged whether the element other than the element of the parts model 18 is present or not in a case where there is no restriction (step S2). Then, it is judged as being before assembling when such element is judged not to be present and the shape 20 before assembling and the common shape 24 before and after assembling are displayed and the shape 22 after assembling is not displayed (step S3). On the other hand, in a case where it is judged that restricting is present at step S1, or it is judged that an element other than the element of parts model 18 is present at step S2, it is judged as being after assembling and the shape 22 after assembling and the common shape 24 before and after assembling are displayed and the shape 20 before assembling is not displayed (step S4), and it is selected whether the shape is displayed or not displayed before and after assembling.

Specifically, as shown in FIG. 5, in a case where the product A comprises parts B, C, D, and E and the part C has a shape changing element whose shape is changed before and after assembling and other common elements, the parts models are generated as model 32 for part B, model 34 for part C, model 36 for part D, and model 38 for part E relative to the product model 30, and the shape 34a before assembling and the common shape 34c before and after assembling are displayed and the shape 34b after assembling is not displayed before assembling, whereas the shape 34a before assembling is not displayed and the shape 34b after assembling and the common shape 34c before and after assembling are displayed respectively after assembling.

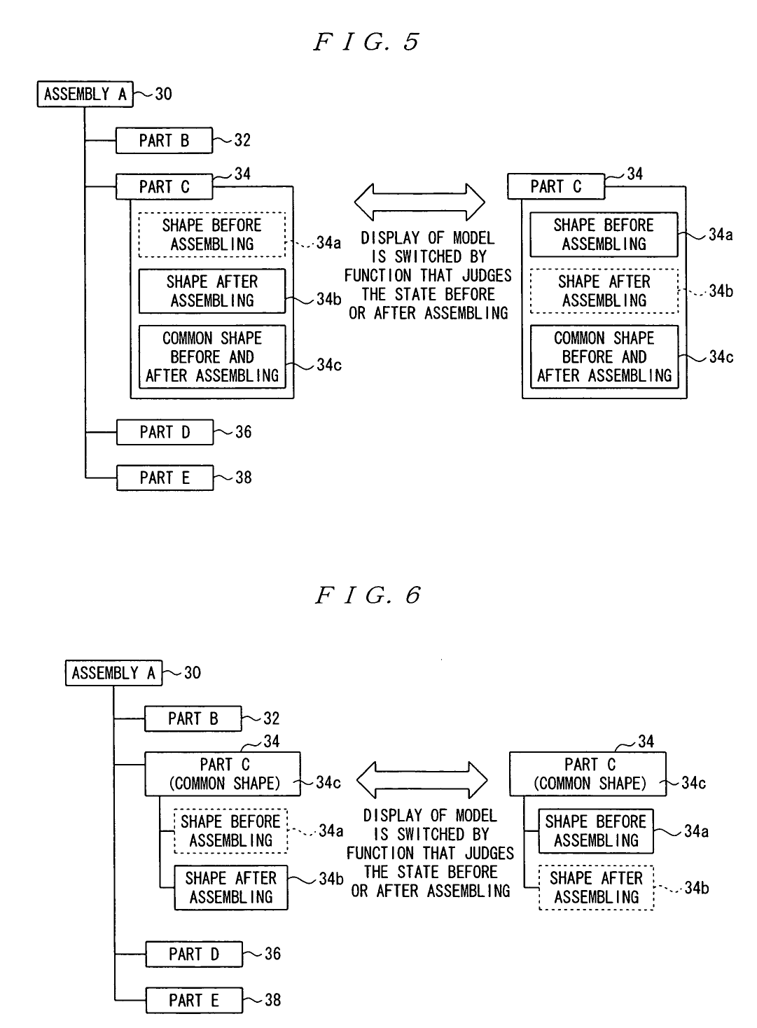

Further, in a case where the shapes before and after the assembling are defined each as sub-assembly, as shown in FIG. 6, the shape 34a before assembling and the common shape 34c before and after assembling are displayed and the shape 34b after assembling is not displayed before assembling, whereas the shape 34a before assembling is not displayed and the shape 34b after assembling and the common shape 34c before and after assembling are displayed after assembling.

As described above, when the product model 30 for the product A is constituted as model 32 for part B, model 34 for part C, model 36 for part D, and model 38 for part E, the product model and the product constituent information can be matched by setting the displayed or not displayed shape before and after assembling.

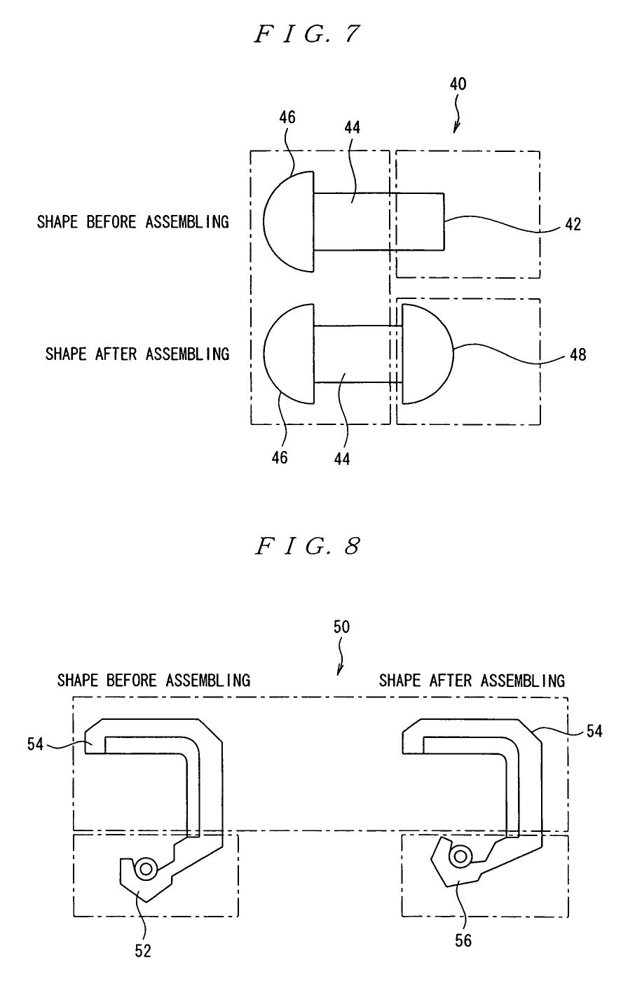

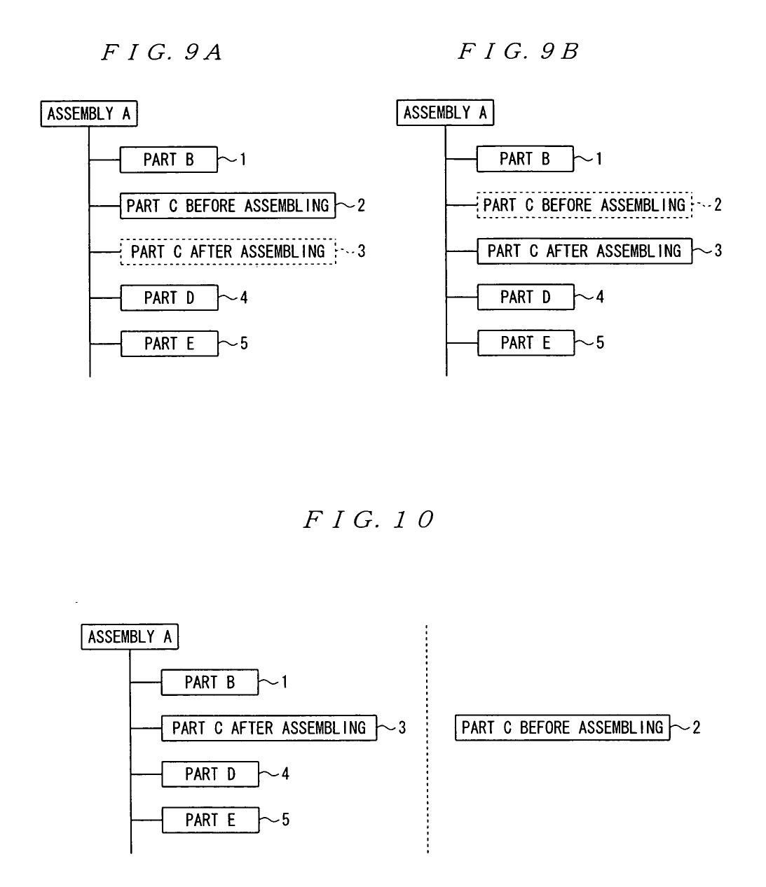

Then, when the three-dimensional shape information stored in the data base 12 is developed into the two-dimensional drawing in accordance with various types of restriction conditions, a two-dimensional drawing, for example, as shown in FIG. 7 is displayed on the screen of the displayed unit 16. Since a rivet 40 changes the shape before and after assembling by caulking, the rivet 40 is divided into a shape changing element 42 whose shape is changed before and after assembling and other common elements 44 and 46. The shape changing element 42 is displayed as a leg before assembling, the common element 44 is displayed as a leg before assembling, and the common element 46 is displayed as a head before assembling. On the other hand, since the shape changing element 42 is changed after assembling into the shape changing element 48, the shape changing element 48 is displayed as a head after assembling, the common element 44 is displayed as the leg also after assembling, and the common element 46 is displayed as a head also after assembling.

Further, as shown in FIG. 8, when an oil seal 50 is developed in the two-dimensional drawing, since the oil seal 50 is divided into a shape changing element 52 whose shape is changed before and after assembling and other common element 54, the shape changing element 52 is displayed and the common element 54 is displayed before assembling. On the other hand, after assembling, since the shape changing element 52 is changed in the shape changing element 56, the shape changing element 56 is displayed, and the common element 54 is displayed as well.

### INDUSTRIAL APPLICABILITY

According to the present invention, the parts model and the two-dimensional drawing can be matched, and the file can be managed easily.

1. A two-dimensional drawings creation method of creating two-dimensional drawings based on a three-dimensional model by using a computer source including a processing device source, a memory source, an input device, and an interface, in which the processing device source executes a processing including a step of holding, as three-dimensional shape information of a parts model having a shape changing element whose shapes is changed before and after assembling and other common elements, three-dimensional information on the shape before assembling and the shape after assembling of the shape changing element and the shape of the common elements, a step of setting a restriction condition between the shape before assembling of the shape changing element and the shape of the common element to become a single part to each other, a step of setting a restriction condition between the shape after assembling of the shape changing element and the shape of the common elements to become a single part to each other, and a step of developing the held three-dimensional information into the two-dimensional drawing in accordance with each of the restriction conditions, based on the operation program of the memory source.

2. The two-dimensional drawing creation method according to claim 1, wherein the method includes; a step of judging the parts model as to whether it is before or after assembling, and not displaying the shape after assembling of the shape changing element, while displaying the shape before assembling of the shape changing element and the shape of the common elements before assembling, and a step of not displaying the shape before assembling of the shape changing element while displaying the shape after assembling of the shape changing elements and the shape of the common element after assembling.

3. A three-dimensional CAD system including a data base that holds, as three-dimensional shape information of a parts model having a shape changing element whose shape is changed before and after assembling and other common elements, three-dimensional information on the shape before assembling and the shape after the assembling of the shape changing element and the shape of the common elements, and a calculation unit that sets a restriction condition between the shape changing element before assembling and the shape of the common elements to become a single part to each other, sets a restriction condition between the shape after assembling of the shape changing element and the shape of the common elements to become a single part to each other, and develops the three-dimensional shape information held in the data base into a two-dimensional drawing in accordance with each of the restriction conditions.

4. The three-dimensional CAD system according to claim 3, including; a display unit for displaying the two-dimensional drawing on a screen, in which the calculation unit judges for the parts model as to whether it is before or after assembling, does not display the shape after assembling of the shape changing elements while displaying the shape before assembling of the shape changing elements and the shape after assembling of the common elements on the display screen before assembling and does not display the shape before assembling of the shape changing element while displaying the shape after assembling of the shape changing elements and the shape of the common elements on the display screen after assembling.

5. A three-dimensional CAD program containing a program for causing a computer to execute a processing attained with each of the means according to claim 3.

6. A recording medium which is a computer-readable recording medium storing the three-dimentional CAD program according to claim 5.
